(19) United States
(12) Patent Application Publication
(10) Pub. No.: US 2007/0118765 A1
(43) Pub. Date: May 24, 2007

(54) Method and system of decrypting disc

(75) Inventor: Peng Yang, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS N.V., Eindhoven (NL)

(21) Appl. No.: 10/577,895

(22) PCT Filed: Nov. 3, 2004
(86) PCT No.: PCT/IB04/52278

§ 371 Date: May 1, 2006

(30) Foreign Application Priority Data
Nov. 6, 2003 (CN) 200310114254.8

(51) Int. Cl. G06F 12/14

(52) U.S. Cl. 713/193

(57) ABSTRACT

This invention provides a method and system for decrypting an optical disc. The contents of the optical disc are encrypted, and the decrypting information is stored in the Internet server. The decrypting information is created by the internet server in terms of the request, including two layers of data, the first layer contains the information related to the data of the optical disc which can not be copied, the second layer contains the encrypted method for decrypting the optical disc. When the optical disc player receives the decrypting information, firstly, it acquires the data from the optical disc to be played which can not be copied according to the information of the first layer, and then decrypts the data of the second layer using the data which can not be copied, thus to acquire the method for decrypting the optical disc and the related parameters.

### BACKGROUND OF THE INVENTION

1. Field of the invention

The invention relates to a method and system of decrypting an optical disc, in particularly to a method and system of acquiring the information for decrypting the disc from the Internet.

2. Description of the related art

Nowadays, when the content providers publish content on an optical disc, whether the disc system can provide a robust copy protection is one of their major concern s. Many copy protection schemes have been adopted on various disc formats, such as Content Scrambling System (CSS) for DVD-Video, Content Protection for Pre-recorded Media (CPPM) for DVD-Audio and Sapphire system for CD2. Usually, cryptographic systems are deployed by these schemes and con tent decryption keys are stored in the secure area on the disc, only the authenticated and verified players can access the decryption keys and decrypt the content correctly. Since these schemes described above are used locally in the player, and cannot be used in the Internet. Further more, now the CSS system has been cracked. The CPPM system is only limited to usage of the DVD-Audio.

FIG. 1 is a schematic diagram of a system that acquires the information for decrypting a disc from the Internet in prior art. When the player 130 starts to play the disc 120, it will request the decrypting information for decrypting the disc from the server 140. The server 140 sends the decryption information to the player 130 after receiving the request via the Internet, then the player 130 decrypts the disc 120 using the decryption information. Since it is to simply change the storage position of the decryption information in the prior art, i.e. from storing in the disc to storing in the server, the security problem for decrypting information can not be solved effectively. Since it is an inevitable trend that next generation disc players will have Internet connectivity built in, we need a scheme suitable for Internet, which can provide the disc decryption information securely.

### SUMMARY OF THE INVENTION

The invention provides a method for decrypting a disc. A disc player acquires the information that can be used to decrypt the disc from the server by sending a request to the server, the information including two layers of data: the first layer containing the information related to the uncopyable data of the disc and the second layer containing the method for decrypting the disc; and then the uncopyable data are obtained from the disc according to the information of the first layer, and used to decrypt the information of the second layer, thereby the method for decrypting the disc and the related parameters thereof are obtained; finally, the method for decrypting the disc and the related parameters thereof are used to decrypt the on-disc content to play.

The invention also provides a method of generating the information for decrypting the disc, in which according to the requests from the player, the uncopyable data of the disc to be played are selected from the prestored data, the prestored data including the data corresponding to the disc to be played; and then the method for decrypting the disc and the related parameters thereof are encrypted using selected uncopyable data, and then a result of encrypting is obtained, and then the method for acquiring the uncopyable data together with the result of encrypting are sent to the player.

The invention makes use of the uncopyable data in the disc to encrypt the method for decrypting the disc and related parameters thereof, the uncopyable data being selected randomly from the prestored data corresponding to the original disc, and for each of the discs or topics, the data selected each time may be different, so the difficulty to crack is increased and reliability during transmitting is improved. When decrypting, it is capable of acquiring the correct method for decrypting the disc and related parameters thereof from original disc only when having the original disc, otherwise it can not be decrypted correctly, so it is effective to preventing the disc from pirating and illegal copying or the like.

Other objectives and advantage of the invention will be obvious from the description as the following and claims with reference to the accompanying drawings, and it will help to comprehend the invention thoroughly.

### BRIEF DESCRIPTION OF THE DRAWINGS

The invention is described in more detail by way of the examples with reference to the accompanying drawings, wherein:

FIG. 1 is a schematic diagram of the convention al system in prior art, which acquires the information for decrypting the disc from Internet;

FIG. 2 is a schematic diagram of the architecture of the disc player according to an embodiment of the invention;

FIG. 3 is a schematic diagram of the architecture of the apparatus that generates the information for decrypting the disc according to an embodiment of the invention;

FIG. 4 is a flowchart of decrypting the disc according to an embodiment of the invention;

FIG. 5 shows the basic architecture of the decrypting information according to the invention;

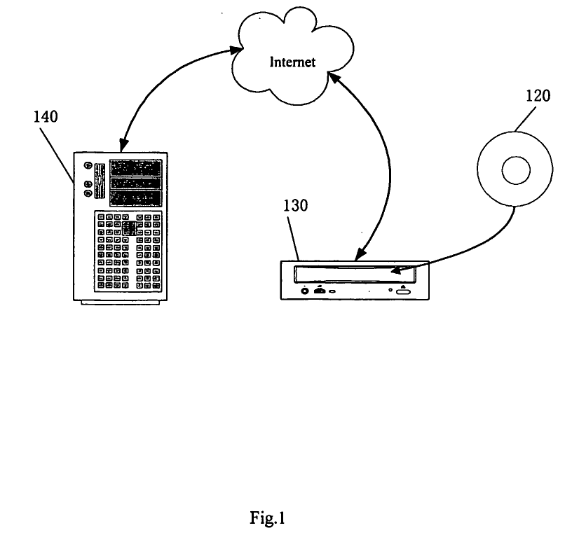

In all the drawings, the same reference numbers refer to the similar or same features and functions. The invention will now be described below with reference to the drawing and in connect with the embodiment.

### DETAILED DESCRIPTION

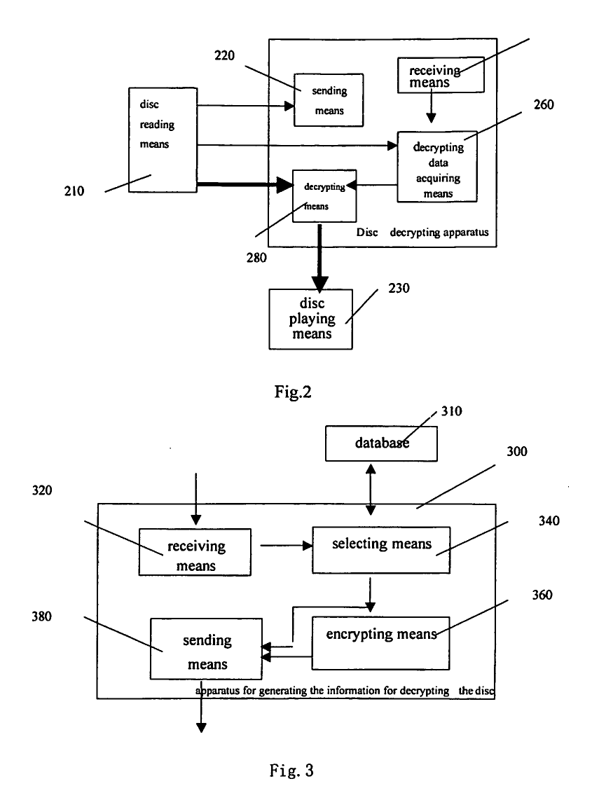

FIG. 2 is a schematic diagram of the architecture of a disc player according to an embodiment of the invention. Same as the conventional disc playing apparatus, the disc player includes a disc reading means 210 for reading the information from the disc, a disc playing means 230 for playing the on-disc content, and the disc player further includes a disc decrypting means 200 for decrypting the encrypted on-disc content.

The disc decrypting means 200 includes a sending means 220 for sending a request via the network requiring the server to provide the decrypting information for decrypting the disc, the request containing the topic information of the disc to be played, and the topic information coming from the disc reading means 210; a receiving means 240 for receiving the decrypting information coming from the server, which decrypting information including two layers of data: the first layer containing the information related to the uncopyable data of the disc, such as the length and position of the disc sector on which the uncopyable data present; the second layer containing the method for decrypting the disc, i.e. the method for decrypting the disc and related parameters thereof encrypted using the uncopyable data of the disc (or the encrypted uncopyable data of the disc). The decrypting information may be transmitted in the form of the e-Ticket in the network. The architecture related to the e-Ticket will be described in detail later.

The disc decrypting means 200 further includes a decrypting data acquiring means 260 for acquiring the uncopyable data of the disc from the disc reading means 210 according to the first layer information of the decrypting information as described above received from the receiving means 240, which is used to decrypt the second layer information, thereby acquiring the method for decrypting the disc and related parameters thereof; and a decrypting means 280 for decrypting the on-disc content to be played sent from the disc reading means 210 using the method for decrypting the disc and related parameters thereof obtained from the decrypting data acquiring means 260, and then sending the decrypted on-disc content to the disc playing means 230 for playing.

FIG. 3 is a schematic diagram of the architecture of an apparatus according to an embodiment of the invention, which generates the information for decrypting the disc. The apparatus 300 for generating the information for decrypting the disc includes a receiving means 320 for receiving a request to decrypt the disc from a player, the request including the topic information of the disc to be played; a selecting means 340 for selecting the corresponding prestored data in a database 310 according to the information in the request received by the receiving means 320, the prestored data including the data corresponding to the disc to be played, such as physical format information of the disc to be played and data information therein. The prestored data may be stored in a virtual disc file corresponding to the disc to be played, or may be stored in the original disc which originates from the same mother disc as the disc to be played. The selecting means 340 selects the uncopyable data of the disc to be played from the prestored data, and the selection is made randomly, and the uncopyable data selected each time may be different;

The apparatus 300 for generating the information for decrypting the disc further includes an encrypting means 360, for encrypting the method for decrypting the disc and the related parameter s thereof using the uncopyable data sent from the selecting means 340, and obtains a result of encrypting; and a sending means 380 for sending the method for acquiring the uncopyable data and the result of encrypting sent from the encrypting means 360 to the player.

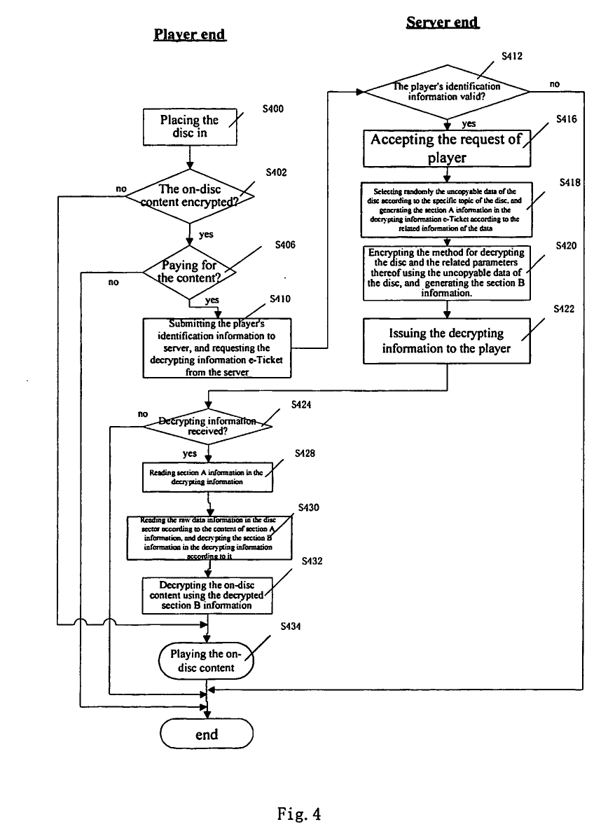

FIG. 4 is a flowchart of decrypting the disc according to an embodiment of the invention. At the player end, when the disc is placed in the player (S400), the player judges whether the on-disc content has been encrypted (S402), and if not, the content will be played normally (S434); and if the on-disc content has been encrypted, the player judges whether the users need to pay for the content (S406), and if the users make a choice of not paying, then the process ends; if the users make a choice of paying, then after the user's paying, the player will submit the identification information of the player to the server for validating, and require the decrypting information e-Ticket for decrypting the on-disc content to the server, the request including the topic information of the disc in the player (S410), so that the server could know which disc the player is playing.

At the server end, firstly, the server validates whether the identification information sent from the player in step S410 is legal and valid (S412), and if the player's identity is illegal, or the player's identity is valid but it has been cracked, or its request format does not meet the requirement, the process ends; and if it is legal and valid, then the server accepts the request that requires for the decrypting information sent by the player in step S410 (S416). Only the validated players can obtain the decrypting information e-Ticket. If a invalidated player is found, the server can revoke the player's legal identity certification, i.e. make the player's identity illegal. The invention is to obtain the decrypting information e-Ticket necessary for decrypting the on-disc content through the server in the network, but the unauthorized or cracked player can not obtain the decrypting information e-Ticket, so it is advantage to revoke the player's rights.

Next, according to the topic information of the disc contained in the received request, the server searches its database to find out the prestored data corresponding to the disc to be played in the player. The prestored data include the uncopyable data corresponding to the disc to be played, such as the physical format information of the disc to be played and the data information therein, and the prestored data may be stored in a virtual disc file corresponding to the disc to be played, or may be stored in the original disc which originates from the same m other disc as the disc to be played. The uncopyable data of the disc to be played are selected randomly from the prestored data (S418), and the information of section A in the decrypting information e-Ticket is generated according to the method for selecting the uncopyable data (see the detailed description below).

The uncopyable data of the disc mentioned above may be the following data:

1. Copyright Management Information (CPR_MAI) of Contents Provider Information (CPI) on a DVD disc, which contains the information about copy protection system and area management, and can not be copied to Read and Write (RW) disc.

2. Disc physical format information, e.g. structure of the disc, layers, area code, etc.

3. Disc manufacturing information, which can not be copied to RW disc. The disc physical format information and disc manufacturing information exists in the control data area of lead-in area.

4. Information in the Burst Cutting Area (BCA) on a DVD disc. The four types of data structure mentioned above had been defined in DVD disc standard, seeing in detail the third chapter of “read-only DVD standard—the first section physical standard (version 1.01)”, the standard documents issued in the DVD forum on December, 1997.

5. Raw data stored on the disc by the content provider, which are indicated by logical/physical sector number and offset value, and are the data extracted before the CSS decryption.

Of course, the uncopyable data are not limited to those listed above. Since they are selected randomly, the raw data may not necessarily be unique for every disc, and need not to be unique for every specific topic. After the uncopyable data is obtained, the uncopyable data of disc may be either encrypted through a special encrypting algorithm, such as hash algorithm, or not, and the method for decrypting the disc and the related parameters thereof (i.e. ciphers, decryption algorithm and parameters or decryption key thereof, etc.) are encrypted using the encrypted data or the unencrypted uncopyable data, and the result of encryption (i.e. the information in section B, as described in detail below) is obtained (S420), at the same time, the generated method for decrypting the disc and related parameters thereof and the results of encryption are stored in e-Ticket, as described in detail below. The Hash algorithm may be MD5, SHA-1, and so on.

At the player end, the player determines whether the decrypting information e-Ticket has been received (S424), and if no, the process ends; and if the e-Ticket has been received, then the information in section A of the e-Ticket is read (S428). According to the information in section A, such as the length and position of the disc sector on which the uncopyable data presents, the uncopyable data on the corresponding position s of the disc to be played in the player are found and read, and if necessary, they may be encrypted using Hash algorithm, then the information in section B are decrypted using the acquired uncopyable data, thereby the method for decrypting the disc and the related parameters thereof (ciphers, decryption algorithm and parameters or decryption key thereof, etc.) are obtained (S430). Next, the on-disc content can be decrypted using the above ciphers, parameters, decryption algorithm or decryption key (S432). Finally, the decrypted on-disc content is played (S434).

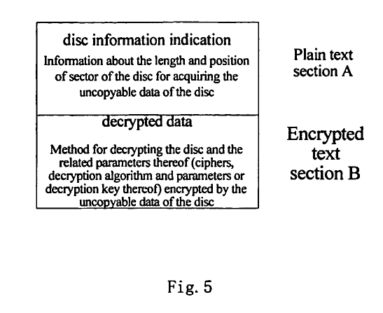

FIG. 5 shows a basic architecture of the decrypting information according to an embodiment the invention. The information in the decrypting information e-Ticket are stored in a structure of two layers, including a plain text body (section A) and an encrypted body (section B). Section A is related to the uncopyable data of the disc, instead of the uncopyable data of the disc itself, and it includes the length and position of the disc sector, and also includes the encrypting algorithm for encrypting the uncopyable data. Section B is the encrypted result obtained by encrypting the method for decrypting the disc and the related parameters thereof (ciphers, decryption algorithm and parameters or decryption key thereof, and so on) using the uncopyable data of the disc or the encrypted uncopyable data of the disc. The decrypting information e-Ticket make use of the structure of two layers to store the data, and the security and reliability of the decrypting information e-Ticket in transmission are increased as compared to the structure of single layer. Furthermore, since the uncopyable data are selected randomly and the randomness is high, the data selected each time may be different for each of the discs or topics, and the difficulty to crack is increased and the security is improved greatly.

In practice, to enable future offline playback (after the first time) of the disc, the embodiment also allows that the decrypting information e-Ticket generated in the server can be stored in the memory device of the player or the disc (if the disc has a writeable area). When the disc is offline playbacking, acquiring the uncopyable data from the original disc to decrypt the decrypting information e-Ticket is also needed.

It is obvious that the decrypting information e-Ticket in the invention may be stored in the player or in the disc, but not like in other systems in which the decrypting information can only be limited in the specific temporary memory of the player strictly. Since the information of section B in the decrypting information e-Ticket is related to the specific original disc, only when the user has both the original disc and e-Ticket, can he decrypt the on-disc content correctly. When there are many e-Tickets presented in the local space, the correspondence relation between the disc and the e-Ticket can be established through each topic of the disc corresponding to the its e-Ticket.

In addition, the content needed to be decrypted is not limited to the on-disc content, and after downloaded and stored in local, the content related to the disc may be decrypted using the method described above.

Although the invention has been described in connect with the embodiments, it is obvious for those skilled in the art that many substitutions, modifications and changes may be made according to the above description. Thus, such substitutions, modifications and changes that fall within the spirit and scope of the following claims should be included in the invention.

What is claimed is:

1. A method for decrypting a n optical disc, comprising:
a. sending a request to the server, which requires server to provide the information for decrypting the optical disc;
b. receiving the decrypting information from the sever, the decrypting information including two layers of data, the first layer contains the information related to the data of the optical disc which can not be copied, the second layer contains the method for decrypting the optical disc;
c. acquiring the data which can not be copied from the optical disc according to the information of said first layer, and using the data to decrypt the information of the second layer to acquire the method for decrypting the optical disc and the related parameters.
d. decrypting the optical disc using the result of step (c).

2. The method according to claim 1, wherein said request includes the topic information of said optical disc.

3. The method according to claim 1, further comprising:
sending the identification information of the player to the server to identify the player for the server.

4. The method according to claim 1, further comprising:
storing said acquired decrypting information into a local storage.

5. A method for generating the information for decrypting the optical disc, comprising:
a. receiving a request from a player, which requires to decrypt an optical disc;
b. selecting the data of the optical disc to be played from the prestored data, which can not be copied, the pre stored data include the data corresponding to the optical disc to be played;
c. encrypting the method for decrypting the optical disc and related parameters using said data which can not be copied, and acquiring the encrypting result;
d. sending the method for acquiring said data which can not be copied and said encrypting result to the player.

6. The method according to claim 5, wherein the data which can not be copied being acquired randomly from said prestored data in step (b).

7. The method according to claim 5, wherein said data which can not be copied including one or more kinds of following data: copyright management information (CPR_MAI), physical format information of the optical disc, manufacturing information of the optical disc, the information in the burst cutting area (BCA).

8. The method according to claim 5, wherein the content of the method in step (d) for acquiring the data which can not be copied including the position and the length of the sector where said data which can not be copied being located.

9. An apparatus for decrypting an optical disc, comprising:
sending means for sending a request to the server, which requires the server to provide the information for decrypting the optical disc;
receiving means for receiving the decrypting information from the sever, said decrypting information including two layers of data, the first layer contains the information related to the data of the optical disc which can not be copied, the second layer contains the method for decrypting the optical disc;
decrypted data acquiring means for acquiring the data which can not be copied from the optical disc according to the information of said first layer, and using the data to decrypt the information of the second layer, thus to acquire the method for decrypting the optical disc and the related parameters; and
decrypting means for decrypting the optical disc using said method for decrypting the compacts disk and the related parameter.

10. The apparatus according to claim 9, wherein the request sent by said sending means including the topic information of the optical disc.

11. The apparatus according to claim 9, wherein said sending means is also used for sending the identification information of the player to identify the player for the server.

12. The apparatus according to claim 9, further comprising:
storing means for storing said decrypting information.

13. An optical disc player, comprising:
optical disc reading means for reading the optical disc information, the optical disc information including the content of the optical disc;
optical disc playing means for playing said content of the optical disc;
optical disc decrypting means for decrypting the optical disc, including:
sending means for sending a request to the server, which requires the server to provide the information for decrypting the optical disc;
receiving means for receiving the decrypting information from the sever, said decrypting information including two layers of data, the first layer contains the information related to the data of the optical disc which can not be copied, the second layer contains the method for decrypting the optical disc;
decrypting data acquiring means for acquiring the data which can not be copied from the optical disc according to the information of said first layer, and using the data to decrypt the information of the second layer, thus to acquire the method for decrypting the optical disc and related parameters;
decrypting means for decrypting the optical disc using said method for decrypting compacts disk and related parameters.

14. An apparatus for generating the information for decrypting the optical disc, comprising:
receiving means for receiving a request from a player, which requires to decrypt an optical disc;
selecting means for selecting the data of the optical disc to be played, which can not be copied, from the prestored data, said prestored data including the data corresponding to the optical disc to be played;
encrypting means for encrypting the method for decrypting the optical disc and related parameters, using the data which can not be copied, and acquiring the encrypting result.
sending means for sending the method for acquiring said data which can not be copied and said encrypting result to the player.

15. The apparatus according to claim 14, wherein said selecting means randomly selecting the data of the optical disc which can not be copied.

16. The apparatus according to claim 14, wherein the data which can not be copied comprising at least one kind of following data: copyright management information (CPR_MAI), physical format information of the optical disc, manufacturing information of the optical disc and the information in the burst cutting area (BCA).
